(19) United States
(12) Patent Application Publication
(10) Pub. No.: US 2023/0317983 A1
(43) Pub. Date: Oct. 5, 2023

(54) Power Cell and Associated Assembly Method

(71) Applicant: Ford Global Technologies, LLC, Dearborn, MI (US)

(72) Inventors: Edward Ball, London (GB); Gautam Chatterji, Cambridge (GB)

(21) Appl. No.: 17/708,675

(22) Filed: Mar. 30, 2022

(51) Int. Cl. H01M 8/04089; H01M 8/0438; H01M 8/2475; B60L 58/30

(52) U.S. Cl. CPC H01M 8/04104; H01M 8/0438; H01M 8/2475; B60L 58/30

(57) ABSTRACT

A power cell and a method of assembling a power cell is described. The power cell comprises a valve operable to vent gas from a power cell housing, the valve comprising a first alignment feature. The power cell further comprises a duct attachable to the power cell housing and configured to direct gas released from the valve, wherein the duct comprises a second alignment feature configured to cooperate with the first alignment feature of the valve, in an assembled configuration.

### BACKGROUND

The present disclosure relates to a power cell and a method of assembling a power cell comprising a valve and a duct. Particularly, but not exclusively, the present disclosure relates to detecting mis-builds during manufacturing of a power cell.

### SUMMARY

With the upcoming changes to regulations required for all electrified vehicle powertrains, power cells, such as battery packs and fuel cells, are required to provide controlled expulsion of vent gases for 5 minutes during a thermal event. The hot gases should be directed away from the vehicle in a controlled manner to help protect the occupants whilst they vacate the vehicle. One of the mechanisms implemented to achieve this is through the use of burst valves that are designed to open at a high pressure, but remain sealed throughout the rest of the vehicle's lifetime. Depending on the vehicle architecture, ducts may be placed around the burst valves to direct the gases away from the vehicle. With a duct in place, the valves (and the alignment of the valves) is no longer visible after assembly.

Previous attempts at ensuring that burst valves perform optimally during a thermal event included performing leak tests, but these will not operate up to the burst valve limits and would not detect a slight mis-build (for example, a burst valve not assembled in the correct alignment).

Once the duct is placed over the valves there is no way to easily check the alignment is correct and the issue may remain undetected until a failure occurs. Accordingly, there is a need to provide a method of ensuring to car manufacturers and service teams that burst valves are assembled in the correct alignment.

The invention is a power cell assembly comprising a duct and a burst valve, wherein the duct is formed around the burst valve in a way that makes it difficult to fit the burst valve without it being in the fully engaged position (i.e., in the correct alignment). This can be done, for example, by providing the duct with slots that, when assembling the duct over the burst valve, directly engage with at least one of the vanes of the burst valve when the burst valve is in the correct alignment. Conversely, when a burst valve is mis-aligned, the slots of the duct do not engage with the burst valve. This allows any mis-builds between the valve and a housing of the power cell to be captured further down the line in plant, as well as provide service technicians with an ability to easily detect a misbuild.

According to examples in accordance with an aspect of the disclosure, a power cell, e.g., a battery pack, a fuel cell, or an electrochemical cell, is provided. The power cell comprises a valve operable to vent gas from a power cell housing, the valve comprising a first alignment feature. The power cell further comprises a duct attachable to the power cell, e.g., to the power cell housing. The duct is configured to direct gas released from the valve. The duct comprises a second alignment feature configured to cooperate with the first alignment feature of the valve, in an assembled configuration, e.g., as the duct is being assembled over the valve. Cooperation between the first alignment feature and the second alignment feature, e.g., without resistance, may indicate that the valve has been installed correctly to the power cell and/or that the valve is not faulty.

In some examples, the first alignment feature is in a first orientation when the valve is correctly fitted to the power cell. For example, if the valve has been incorrectly installed to the power cell housing and/or is inherently faulty, the first alignment feature will not be in a desired location/orientation when the valve is assembled to the power cell housing. Misalignment between the first and second alignment features may indicate that the valve has not been installed correctly to the power cell and/or that the valve is faulty.

In some examples, the power cell comprises a set of locating features configured to locate the duct relative to the housing, in an assembled configuration. For example, the power cell housing may comprise one or more standalone features configured to ensure that the duct is assembled to the power cell housing in a correct position/orientation. Additionally or alternatively, the duct may be aligned to the power cell housing by virtue of one or more fasteners used to attach the duct to the power cell housing.

In some examples, the duct is attachable to the valve. For example, the duct may have one or more features configured to interact with the valve in order to secure the duct to, e.g., directly to, the valve, e.g., without attachment to the power cell housing.

In some examples, one of the first alignment feature and the second alignment feature comprises a protruding feature, and the other of first alignment feature and the second alignment feature comprises a recessed feature.

In some examples, the valve hermetically seals the battery pack.

In some examples, the valve is a burst valve operable to vent gases away from the battery pack if a pressure within the battery pack is at or above a predetermined threshold. In some examples, the valve may be actuated by one or more mechanisms, e.g., that are controlled by a vehicle controller depending on an operating state of the power cell and/or the vehicle.

According to some examples in accordance with another aspect of the disclosure, a vehicle is provided. The vehicle comprises a power cell, which comprises a valve operable to vent gas from a power cell housing, the valve comprising a first alignment feature. The power cell further comprises a duct attachable to the power cell, e.g., to the power cell housing, and configured to direct gas released from the valve, wherein the duct comprises a second alignment feature configured to cooperate with the first alignment feature of the valve, in an assembled configuration.

According to some examples in accordance with another aspect of the disclosure, a valve for a power cell is provided. The valve is attachable to a housing of the power cell and operable to vent gas from the housing of the power cell towards a duct of the power cell in an assembled configuration. The valve comprises a first alignment configured to cooperate with a second alignment feature of the duct.

According to some examples in accordance with another aspect of the disclosure, a duct for a power cell is provided. The duct is attachable to a housing of the power cell and operable to direct gas away from a valve in the housing of the power cell in an assembled configuration. The duct comprises a second alignment feature configured to cooperate with a first alignment feature of a valve.

According to examples in accordance with another aspect of the disclosure, a method of assembling a power cell is provided, the power cell comprising a valve and a duct, the valve having a first alignment feature and the duct having a second alignment feature. The method comprises fitting the valve to a housing of the power cell and fitting the duct to the housing power cell when the first alignment feature is aligned with the second alignment feature.

In the context of the present disclosure, a vehicle may be any appropriate type of vehicle, such as an automobile, a motorbike, a marine vessel, or an aircraft. In some examples, the vehicle may be any appropriate type of hybrid vehicle, such as a Hybrid Electric Vehicle (HEV), a Plug-in Hybrid Electric Vehicle (PHEV), a Mild Hybrid Electric Vehicle (mHEV), or any other vehicle having an engine and an electrified powertrain. In some examples, the systems and methods described herein may be used on or with any machinery or equipment, for example, a generator, requiring operational control by a user/operator.

Moreover, in the context of the present disclosure, the term “driver” or “user” may mean any person who operates a vehicle or any machinery or equipment.

These examples and other aspects of the disclosure will be apparent and elucidated with reference to the example(s) described hereinafter. It should also be appreciated that particular combinations of the various examples and features described above and below are often illustrative and any other possible combination of such examples and features are also intended, notwithstanding those combinations that are intended as mutually exclusive.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 illustrates a top-down view of a power cell comprising a valve and a duct, in accordance with some examples of the disclosure;

FIG. 2A illustrates a top-down view of a power cell comprising possible relative orientations of a valve and a duct, in accordance with some examples of the disclosure;

FIG. 2B illustrates a top-down view of a power cell comprising possible relative orientations of a valve, a duct, and a vane slot, in accordance with some examples of the disclosure;

FIG. 2C illustrates a perspective view of a power cell comprising a valve, a duct and a vane slot, in accordance with some examples of the disclosure;

FIG. 3 illustrates a top-down view of a valve for a power cell, in accordance with some examples of the disclosure;

FIG. 4 illustrates a top-down view of a duct for a power cell, in accordance with some examples of the disclosure;

FIG. 5 is a flow chart illustrating a method for assembling a power cell, in accordance with some examples of the disclosure; and

FIG. 6 is a vehicle having a power cell, in accordance with some examples of the disclosure.

### DETAILED DESCRIPTION

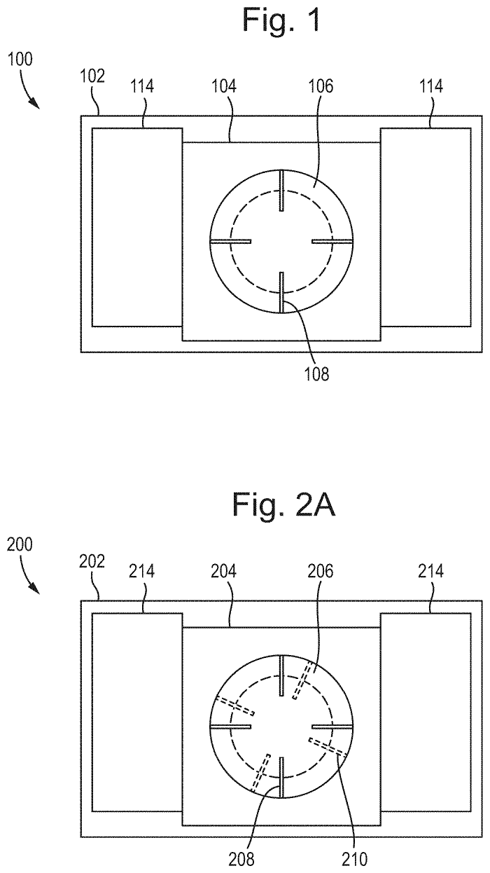

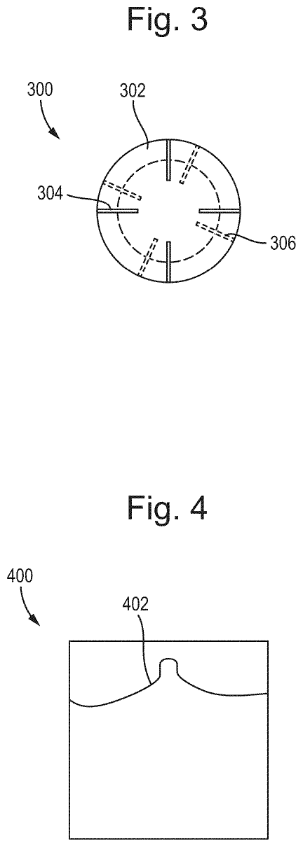

FIG. 1 illustrates a top-down view of a power cell 100 for a vehicle, such as the vehicle 600 depicted in FIG. 6 as described below. Power cell 100 comprises a power cell housing 102 operable to house any type of power cell, e.g., a battery (not shown), for the vehicle. While the below example continues with the example where the power cell comprises a battery back, it is to be understood that such an example is not limited to such. Additionally, the terms such as “top down” and “side view”, etc., are used in relation to the views in the accompanying drawings, and are not intended to limit the orientation of the claimed features in use. Power cell 100 comprises a valve 106 operable to provide a controlled expulsion of vent gas (for example, during a thermal event) from the power cell housing 102. In some examples, valve 106 may be a burst valve operable to open if a pressure within the power cell housing 102 is at or above predetermined threshold but remains sealed throughout the rest of the vehicle's 600 lifetime. Valve 106 may additionally comprise a first alignment feature 108 operable to ensure that valve 106 is aligned correctly on power cell housing 102, e.g., as described in more detail below with reference to FIG. 3.

To direct gases from the power cell housing 102 away from the vehicle 600 in a controlled manner, power cell 100 may further comprise a duct 104 attachable to the power cell housing 102 and placed around the valve 106. In such a case, once the duct is installed to the power cell, the valve 106 (and the alignment of the valve 106) may no longer be visible after assembly. In some examples, power cell housing 102 may comprise a plurality of valves 106. In further examples, power cell housing 102 may comprise a plurality of ducts 104, each of which may be placed around one or more of the plurality of valves 106.

In some embodiments, power cell housing 102 may comprise a set of locating features 114 configured to locate the duct 104 relative to the power cell housing 102, in an assembled configuration. Locating features 114 may, for example, be a plurality of protruding plates affixed to same side of the power cell housing 102 as the duct 104, and in a same plane as the duct 104. Locating features 114 may additionally be on opposite sides of the duct 104, as shown in FIG. 1 to act as a guiding track for duct 104 when duct 104 is in an assembled configuration to ensure duct 104 is placed securely onto power cell housing 102. In some embodiments, locating features may comprise stabilizing features (for example, fasteners and/or adhesive) to secure them to the power cell housing 102.

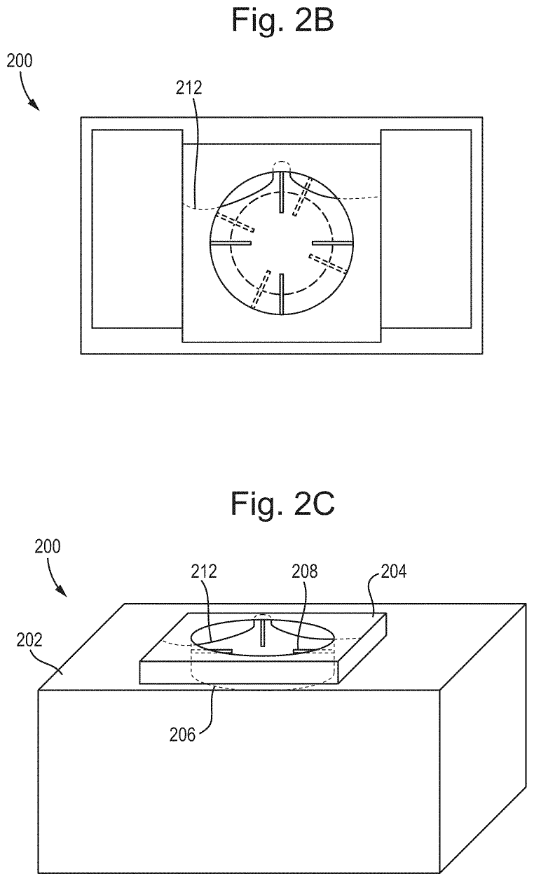

FIGS. 2A-2C illustrate various views of a power cell 200 for a vehicle, such as the vehicle 600 depicted in FIG. 6 as described below. Power cell 200 substantially corresponds to power cell 100 as described in FIG. 1 above, and may comprise a power cell housing 202, duct 204, valve 206, a first alignment feature 208, and a set of locating features 214. Power cell housing 202 substantially corresponds to power cell housing 102, duct 204 substantially corresponds to duct 104, valve 206 substantially corresponds to valve 106, first alignment feature 208 substantially corresponds to first alignment feature 108, and stabilizing features 114 substantially correspond to stabilizing features 214 as described in FIG. 1 above.

During manufacturing of power cell 200, a valve (such as valve 206) is attached to a hole in the fuel hell housing 202, for example, by screwing the valve into the hole. In some cases, the valve 206 may not be correctly seated in the hole in the housing 202, which may result in the valve 206 (and the first alignment feature 208) not being orientated correctly (as shown by 210 in FIG. 2A). When the duct 204 is placed over valve 206 during assembly of the power cell 202, the valve 206 (and the misalignment of the valve) is no longer visible.

To address this problem and provide a simple arrangement of identifying that valve 206 is (or is not) seated correctly at the point of assembly, duct 204 may comprise a second alignment feature 212 as shown in FIGS. 2B and 2C. The second alignment feature 212 may be a recessed feature which, when duct 204 is attached to power cell housing 202, is configured to cooperate with the first alignment feature 208 of valve 206 if valve 206 is in the correct alignment. If valve 206 is not correctly seated on the housing 202, then it will not be possible to attach duct 204 to power cell housing 202 because the second alignment feature 212 of duct 204 will not cooperate, e.g., without resistance or expected interference, with the first alignment feature 208 of valve 206. Advantageously, this provides a simple arrangement of identifying that valve 300 is not seated correctly at the point of assembly. The first alignment feature 208 of valve 206 and the second alignment feature 212 of duct 204 are described in more detail below with reference to FIGS. 3 and 4.

In FIG. 2C valve 206 is depicted as being recessed into power cell housing 202. However, valve 206 may protrude out of power cell housing 202 in some examples. Furthermore, duct 204 is depicted as protruding from power cell housing 202. In some examples, duct 204 may be recessed into power cell housing 202 such that it sits flush to the edge of power cell housing 202.

FIG. 3 illustrates a top-down view of a valve 300, for example, for use in a power cell 100, 200 as depicted in FIGS. 1 and 2A-2C. Valve 300 may be a cylindrical valve operable to vent gases from a closed chamber within a power cell if the pressure within the closed chamber is above a predetermined threshold. In some examples, valve 300 may be a burst valve. However, valve 300 may also be any other type of valve suitable for venting gases from a closed chamber. In further examples, the closed chamber is at least a portion of the power cell housing 102, and 202 as depicted in FIGS. 1, and 2A-2C. Valve 300 may comprise a closing element 302. In some examples, the closing element 302 is a spring-loaded cover which sits on a valve seat (not shown) to hermetically seal the closed chamber.

Valve 300 may additionally comprise a first alignment feature 304 operable to indicate that valve 300 is seated correctly on power cell housing 102, 202, e.g., by virtue of engagement with one or more other features. The first alignment feature 304 may comprise at least one protruding feature (for example, a vane) on the outer side of the valve 300, i.e., outside of the power cell housing 102, 202. In some examples, the at least one protruding feature 304 (for example, vane) extends away from a body of the valve 300. In some examples, the protruding feature 304 is formed integral to, or unitary with, a remainder of the valve. Additionally or alternatively, at least one protruding feature may be attachable to a valve, e.g., in a manner that limits or restricts the position/orientation of the protruding feature 304 relative to a remainder of the valve. Irrespective of the exact manner in which the protruding feature 304 is provided on the valve 300, a relationship exists between the position/orientation of the protruding feature 304 and the quality and/or accuracy of the installation of the valve 300 to the power cell housing. As described above with reference to FIGS. 1 and 2A-2C, when valve 300 is attached to power cell housing 102, 202, valve 300 may not be seated correctly on the fuel housing 102, 202, leading to first alignment feature 304 also not being orientated correctly, as shown in 306 of FIG. 3. Valve 300 may be adjusted, for example, by twisting it, to change the orientation of the first alignment feature 304, such that the first alignment feature 304 is in a first orientation wherein the valve is correctly fitted to the power cell 100, 200.

FIG. 3 depicts a valve 300 wherein the first alignment feature 304 comprises four protruding features (or, in incorrect valve attachment, four misaligned protruding features 306) that are equidistant from each other. Depending on the requirements of which direction any vented gases are to be directed from a closed chamber or a power cell housing 102, 202, valve 300 may comprise any number of protruding features. Similarly, depending on which direction the vented gases are to be directed from the closed chamber or the power cell housing 102, 202, the one or more protruding features may or may not be equidistant from each other. In other words, the alignment feature 304 of the valve 300 may have any appropriate configuration, e.g., depending on one or more desired characteristics of the venting of gas from the valve 300.

FIG. 4 illustrates a top-down view of a duct 400, for example, for use in a power cell 100, 200 as depicted in FIGS. 1 and 2A-2C. Duct 400 may be attachable to the power cell housing 102, 202 of power cell 100, 200 and/or may be attached to valve 300 such that duct 400 substantially cover valve 300 as depicted in FIG. 3, to direct vented gas released from valve 300. Duct 400 may comprise a second alignment feature 402 which, when duct 400 is attached to (or at least being attached to) the power cell housing 102, 202, is configured to cooperate with the first alignment feature 304 (for example, the at least one protruding feature/vane as described above with reference to FIG. 3). The second alignment feature 402 may be recessed feature, for example, a slot operable to fit around at least one of the protruding features/vanes 304 if the valve is correctly seated on the power cell housing 102, 202. If valve 300 is not correctly seated on or in the power cell housing 102, 202, then the at least one protruding feature/vane 304 (by virtue of being attached to the valve 300) will not be correctly orientated. When attempting to attach duct 400 onto a valve 300 of power cell housing 102, 202, the second alignment feature 402 will not cooperate, e.g., easily cooperate, with the first alignment feature 304 (for example, the at least one protruding feature/vane 304 will not slot into the recessed feature/vane slot 402) which, in turn, will at least partially prevent duct 400 from being attached to power cell housing 102, 202. Advantageously, this provides a simple arrangement of identifying that valve 300 is not installed correctly at the point of assembly.

FIG. 4 is depicted as showing a duct 400 comprising a single second alignment feature 402. However, duct 400 may comprise any number of second alignment features 402, for example, one for each protruding feature/vane 304 of valve 300. In other examples, duct 400 may comprise a plurality of second alignment features 402 to cooperate with a first alignment feature 304 (for example, at least one protruding feature/vane) of a plurality of valves 300. In such an example, each of the plurality of second alignment features 402 may be operable to cooperate with at least one protruding feature/vane 304 of each of the plurality of valves 300.

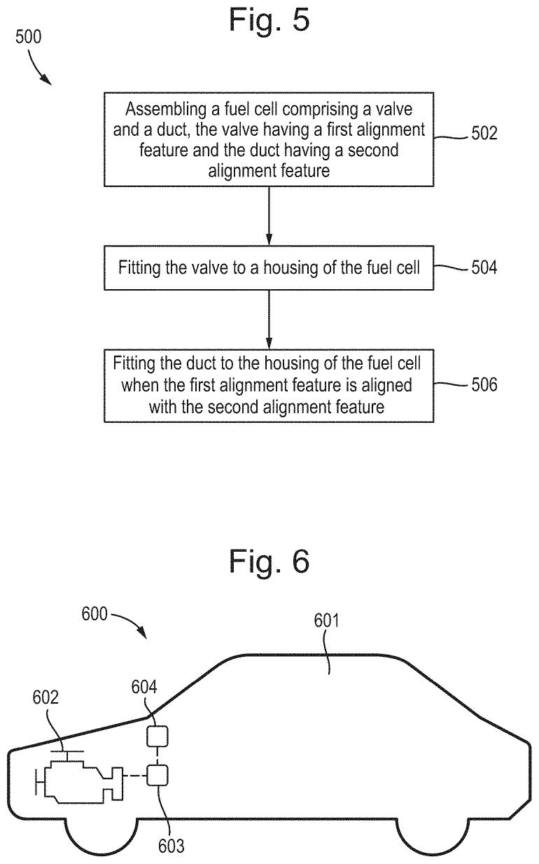

FIG. 5 is a flow chart illustrating a method 500 for assembling a power cell 100, 200 as described above with reference to FIGS. 1-4. Step 502 describes the method for assembling a power cell 100, 200 comprising a valve (for example, valve 106, 206, 300 as described above with reference to FIGS. 1-3) and a duct (for example, duct 104, 204, 400 as described above with reference to FIGS. 1-2 and 4). The valve has a first alignment feature (for example, first alignment feature 108, 208, 304 as described above with reference to FIGS. 1-3) and the duct has a second alignment feature (for example, second alignment feature 202, 402 as described above with reference to FIGS. 2 and 4).

In step 504, the method comprises fitting the valve 106, 206, 300 to a housing (for example, power cell housing 102, 202 as described above with reference to FIGS. 1 and 2A-2C) of the power cell (for example, power cell 100, 200 as described above with reference to FIGS. 1 and 2A-2C).

In step 506, the method comprises fitting the duct 104, 204, 400 to the housing 102, 202 of the power cell 100, 200 when the first alignment feature 108, 208, 304 is aligned with the second alignment feature 202, 402.

FIG. 6 is a vehicle 600 having a power cell 603 (for example, the power cell as described in FIGS. 1-2), in accordance with some examples of the disclosure. The vehicle 600 has a body 601 housing a motor 602, shown at the front of the vehicle 600. Within the body of the vehicle 600 there is a power cell 603 and a controller 604 (for example, any type of computer). The power cell 603 is connected via a wiring loom (not shown) to the controller 604. The controller 604 is connected to the motor 602 also via the wiring loom. The controller 604 may be operationally coupled to the power cell 603 to cause the motor 602 of the vehicle 600 to be started or stopped, e.g., depending on an operational state of the power cell 603.

The below items are also included in accordance with some examples of the disclosure.

Item 1 is a power cell comprising a valve operable to vent gas from a power cell housing, the valve comprising a first alignment feature; and a duct attachable to the power cell housing and configured to direct gas released from the valve, wherein the duct comprises a second alignment feature configured to cooperate with the first alignment feature of the valve, in an assembled configuration.

Item 2 is a power cell of item 1, wherein the first alignment feature is in a first orientation when the valve is correctly fitted to the power cell.

Item 3 is a power cell of any of the above items, wherein the power cell comprises a set of locating features configured to locate the duct relative to the housing, in an assembled configuration.

Item 4 is a power cell of any of the above items, wherein the duct is attachable to the valve.

Item 5 is a power cell of any of the above items, wherein one of the first alignment feature and the second alignment feature comprises a protruding feature, and the other of first alignment feature and the second alignment feature comprises a recessed feature.

Item 6 is a power cell of any of the above items, wherein the valve is a burst valve operable to vent gases away from the power cell if a pressure within the power cell is at or above a predetermined threshold.

Item 7 is a vehicle comprising the power cell of any of the above items.

Item 8 is a valve for a power cell, the valve being attachable to a housing of the power cell and operable to vent gas from the housing of the power cell towards a duct of the power cell in an assembled configuration, the valve comprising a first alignment configured to cooperate with a second alignment feature of the duct.

Item 9 is a duct for a power cell, the duct being attachable to a housing of the power cell and operable to direct gas away from a valve in the housing of the power cell in an assembled configuration, the duct comprising a second alignment feature configured to cooperate with a first alignment feature of a valve.

Item 10 is a method of assembling a power cell comprising a valve and a duct, the valve having a first alignment feature and the duct having a second alignment feature, the method comprising: fitting the valve to a housing of the power cell; and fitting the duct to the housing power cell when the first alignment feature is aligned with the second alignment feature.

Item 11 is a method of item 10 wherein the first alignment feature is in a first orientation when the valve is correctly fitted to the power cell.

Item 12 is a method of items 10 to 11, wherein the power cell comprises a set of locating features configured to locate the duct relative to the housing, in an assembled configuration.

Item 13 is a method of items 10 to 12, wherein the duct is attachable to the valve.

Item 14 is method of items 10 to 13, wherein one of the first alignment feature and the second alignment feature comprises a protruding feature, and the other of first alignment feature and the second alignment feature comprises a recessed feature.

Item 15 is a method of items 10 to 14, wherein the valve is a burst valve operable to vent gases away from the power cell if a pressure within the power cell is at or above a predetermined threshold.

The processes described above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one example may be applied to any other example herein, and flowcharts or examples relating to one example may be combined with any other example in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A power cell comprising:
a valve operable to vent gas from a power cell housing, the valve comprising a first alignment feature; and
a duct attachable to the power cell housing and configured to direct gas released from the valve, wherein the duct comprises a second alignment feature configured to cooperate with the first alignment feature of the valve, in an assembled configuration.

2. The power cell of claim 1, wherein the first alignment feature is in a first orientation when the valve is correctly fitted to the power cell.

3. The power cell of claim 1, wherein the power cell comprises a set of locating features configured to locate the duct relative to the housing, in an assembled configuration.

4. The power cell of claim 1, wherein the duct is attachable to the valve.

5. The power cell of claim 1, wherein one of the first alignment feature and the second alignment feature comprises a protruding feature, and the other of first alignment feature and the second alignment feature comprises a recessed feature.

6. The power cell of claim 5, wherein the valve is a burst valve operable to vent gases away from the power cell if a pressure within the power cell is at or above a predetermined threshold.

7. A vehicle comprising the power cell of claim 1.

8. A method of assembling a power cell comprising a valve and a duct, the valve having a first alignment feature and the duct having a second alignment feature, the method comprising:
fitting the valve to a housing of the power cell; and
fitting the duct to the housing power cell when the first alignment feature is aligned with the second alignment feature.

9. The method of claim 8, wherein the first alignment feature is in a first orientation when the valve is correctly fitted to the power cell.

10. The method of claim 8, wherein the power cell comprises a set of locating features configured to locate the duct relative to the housing, in an assembled configuration.

11. The method of claim 8, wherein the duct is attachable to the valve.

12. The method of claim 8, wherein one of the first alignment feature and the second alignment feature comprises a protruding feature, and the other of first alignment feature and the second alignment feature comprises a recessed feature.

13. The method of claim 12, wherein the valve is a burst valve operable to vent gases away from the power cell if a pressure within the power cell is at or above a predetermined threshold.
